(19) United States
(12) Patent Application Publication
(10) Pub. No.: US 2011/0063681 A1
(43) Pub. Date: Mar. 17, 2011

(54) IMAGE PROCESSING APPARATUS AND COMPUTER READABLE MEDIUM STORING PROGRAM

(75) Inventor: Takeshi ONISHI, Ashigarakami-gun (JP)

(73) Assignee: FUJI XEROX CO., LTD., Tokyo (JP)

(21) Appl. No.: 12/729,009

(22) Filed: Mar. 22, 2010

(30) Foreign Application Priority Data
Sep. 14, 2009 (JP) 2009-212077

(51) Int. Cl. G06K 15/02

(52) U.S. Cl. 358/1.18

(57) ABSTRACT

An image processing apparatus includes: a document image acquisition unit that acquires a document image; an additional information image acquisition unit that acquires an additional information image in which additional information added to the document image acquired by the document image acquisition unit is represented with a dot array of dots having a predetermined size and interval; a determination unit that determines an arrangement of at least one of the document image and the additional information image so as to reduce interference in superposition of the document image acquired by the document image acquisition unit and the additional information image acquired by the additional information image acquisition unit; and a superposition unit that superposes the document image on the additional information image in the arrangement determined by the determination unit.

### CROSS-REFERENCE TO RELATED APPLICATIONS

This application is based on and claims priority under 35 USC 119 from Japanese Patent Application No. 2009-212077 filed Sep. 14, 2009.

### BACKGROUND

### Technical Field

The present invention relates to an image processing apparatus and a computer readable medium storing a program.

### SUMMARY

According to an aspect of the present invention, there is provided an image processing apparatus including: a document image acquisition unit that acquires a document image; an additional information image acquisition unit that acquires an additional information image in which additional information added to the document image acquired by the document image acquisition unit is represented with a dot array of dots having a predetermined size and interval; a determination unit that determines an arrangement of at least one of the document image and the additional information image so as to reduce interference in superposition of the document image acquired by the document image acquisition unit and the additional information image acquired by the additional information image acquisition unit; and a superposition unit that superposes the document image on the additional information image in the arrangement determined by the determination unit.

### BRIEF DESCRIPTION OF THE DRAWINGS

An exemplary embodiment of the present invention will be described in detail based on the following figures, wherein:

FIG. 1 illustrates an image processing system having an image processing apparatus as an exemplary embodiment of the present invention;

FIG. 2 is a block diagram showing a functional configuration when the respective devices in FIG. 1 embed additional information;

FIG. 3 illustrates an example of additional information image data;

FIG. 4 is an explanatory view of determination of an arrangement of additional information image data in document image data; and

FIG. 5 is a block diagram showing a functional configuration when the image processing apparatus in FIG. 1 detects additional information.

### DETAILED DESCRIPTION

Hereinbelow, an exemplary embodiment of the present invention will be described in detail based on the drawings.

Note that the following description is merely an example upon implementation of the present invention. The present invention is not limited to the following description, and appropriate changes can be made in accordance with necessity.

### [Image Processing System]

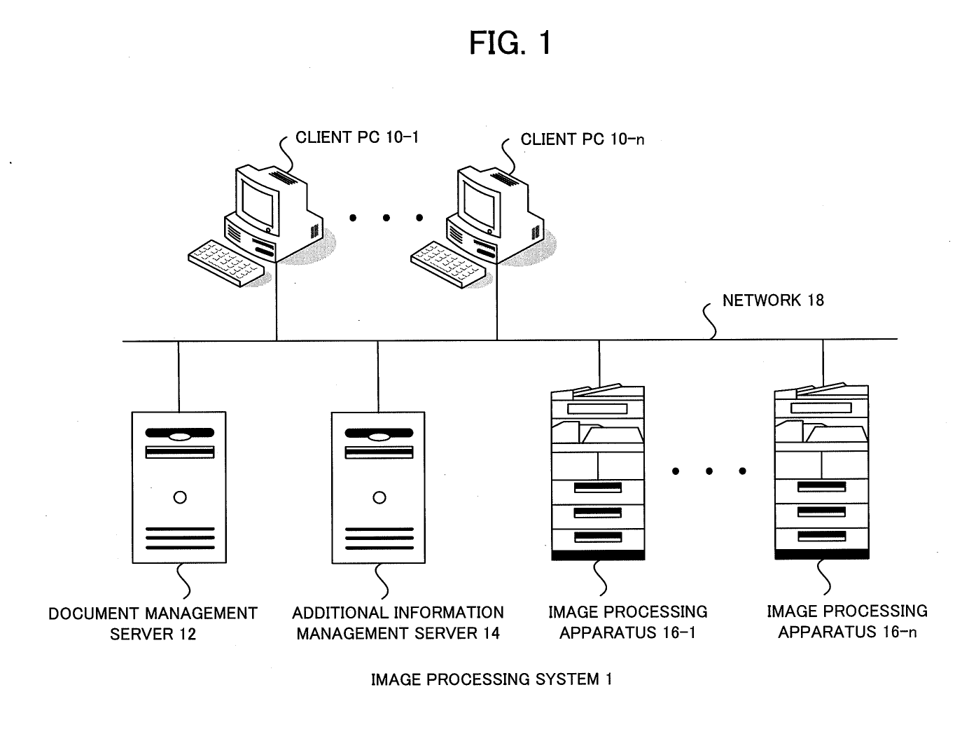

FIG. 1 illustrates an image forming system 1 having image processing apparatuses 16 as an exemplary embodiment of the present invention. As shown in FIG. 1, in the image processing system 1, client PCs 10-1 to 10-n each having general computer functions, a document management server 12 to hold electronic documents (e.g., a document generated using an application such as MS Word (registered trademark); hereinbelow, simply referred to as a “document”), an additional information management server 14 to hold information on the documents and additional information allocated to the documents, linked to each other, and the image processing apparatuses 16-1 to 16-n each having plural functions such as a copying function, a printing function and a facsimile transmission function, are interconnected via a network 18.

In the above construction, the client PC 10, the document management server 12, the additional information management server 14 and the image processing apparatuses 16 mutually transmit/receive information.

In the respective drawings, substantially corresponding constituent elements have the same reference numerals.

Hereinbelow, when any one of plural constituent elements such as the “client PCs 10-1 to 10-n” is shown without being particularly specified, it may be simply referred to as a “client PC 10” or the like (note that “n” does not always indicate the same number).

### [Embedding of Additional Information]

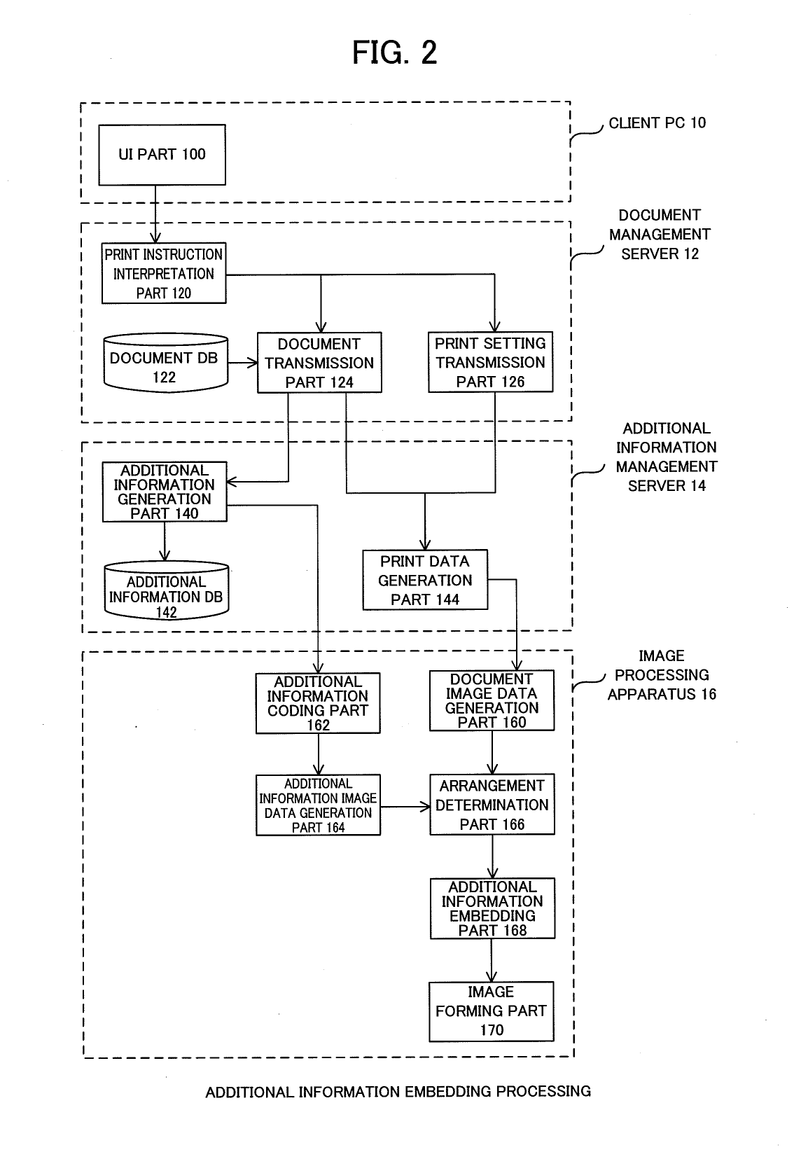

FIG. 2 is a block diagram showing a functional configuration when the respective devices in FIG. 1 (the client PC 10, the document management server 12, the additional information management server 14 and the image processing apparatuses 16) embed additional information.

The functions shown in FIG. 2 are realized by execution of a computer program by a CPU in the respective devices. Note that the computer program may be stored in a memory or a storage medium such as an HDD (Hard Disk Drive) in the respective devices, and further, may be stored on an external storage medium such as a ROM (Read Only Memory), a RAM (Random Access Memory) or a floppy disc (registered trademark) and provided. Otherwise, the computer program may be provided via an electric communication line such as a public line as typified by the Internet as a computer-readable electric signal.

The client PC 10 has a user interface part (hereinbelow, “UI part”) 100, and the document management server 12 has a print instruction interpretation part 120, a document database (DB) 122, a document transmission part 124 and a print setting transmission part 126.

Further, the additional information management server 14 has an additional information generation part 140, an additional information DB 142 and a print data generation part 144. The image processing apparatus 16 has a document image data generation part 160, an additional information coding part 162, an additional information image data generation part 164, an arrangement determination part 166, an additional information embedding part 168 and an image forming part 170.

Hereinbelow, the above respective elements will be described.

### [Client PC]

The UI 100 part receives a print instruction from a user and transmits it to the document management server 12.

### [Document Management Server]

The print instruction interpretation part 120 interprets the print instruction received from the client PC 10 and extracts information on a document as a subject of printing and information on print settings for the document (e.g., setting for printing in A4 size and printing image data for 2 pages on one side of one recording sheet).

The document transmission part 124 extracts the document which is the subject of printing from the document DB 122 and transmits it to the additional information management server 14.

The print setting transmission part 126 transmits the print settings to the additional information management server 14.

### [Additional Information Management Server]

The additional information generation part 140 generates additional information with the reception of the document from the document management server 12 as a trigger. Note that the additional information may be selected from previously generated information. In this case, the additional information generation part is replaced with an additional information selection part.

The additional information generated by the additional information generation part 140 is allocated to the document received from the document management server 12, registered in the additional information DB 142 with linkage to the information on the document (e.g., document print settings and document storage location) and transmitted to the image processing apparatus 16.

Note that the additional information generation part 140 generates additional information and allocates the information to each recording sheet on which image data is to be print-outputted. For example, when the document has 10 pages and image data for 2 pages is print-outputted on one side of one recording sheet, the additional information generation part 140 generates 10/2=5 additional information pieces and allocates the additional information to each recording sheet.

The print data generation part 144 generates print data based on the document and print settings received from the document management server 12. More particularly, the print data generation part 144 generates print data described in Page Description Language (PDL) based on the document and print settings received from the document management server 12, and transmits the print data to the image processing apparatus 16.

Note that in this example, the print data is generated in the additional information management server 14; however, the print data may be generated in the image processing apparatus 16.

### [Image Processing Apparatus]

The document image data generation part 160 generates image data represented in bitmap format or the like based on the print data received from the additional information management server 14.

The additional information coding part 162 encodes the additional information received from the additional information management server 14. Note that the additional information coding part 162 may encode the additional information together with redundant data to correct errors in detection of the additional information by BCH error correction coding or the like.

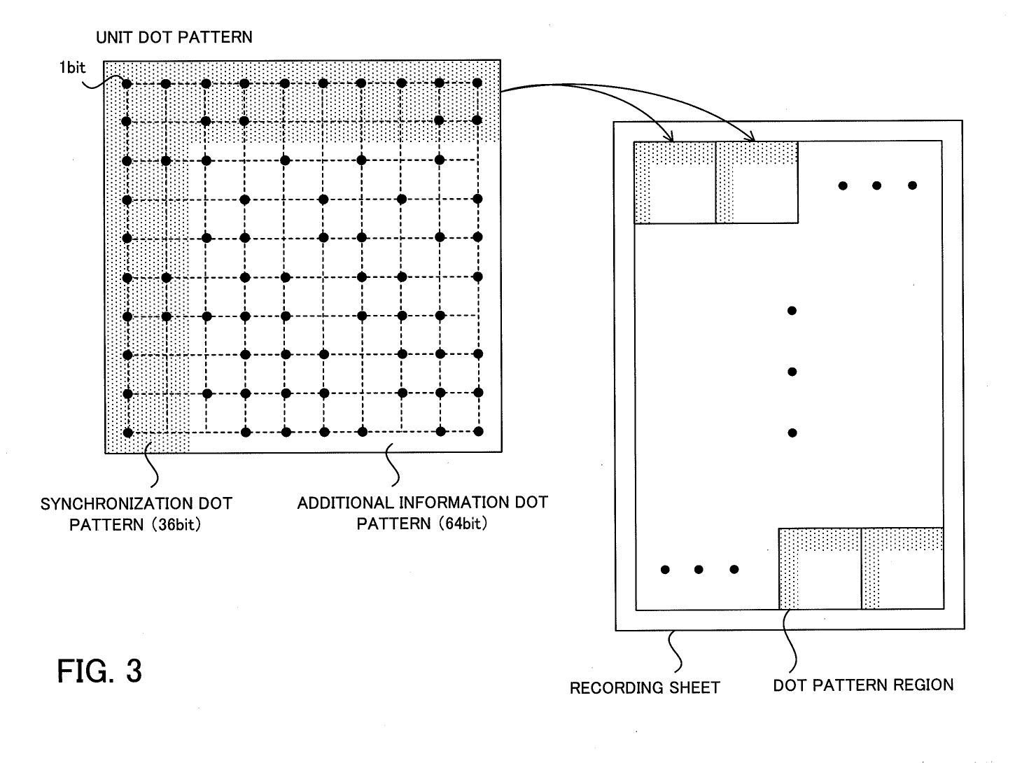

The additional information image data generation part 164 generates image data (unit image data) represented as a dot pattern or the like based on the additional information encoded by the additional information coding part 162. Further, the additional information image data generation part 164 arranges the generated unit image data in a dot pattern region corresponding to the size of the recording sheet. The details will be described later with reference to FIG. 3.

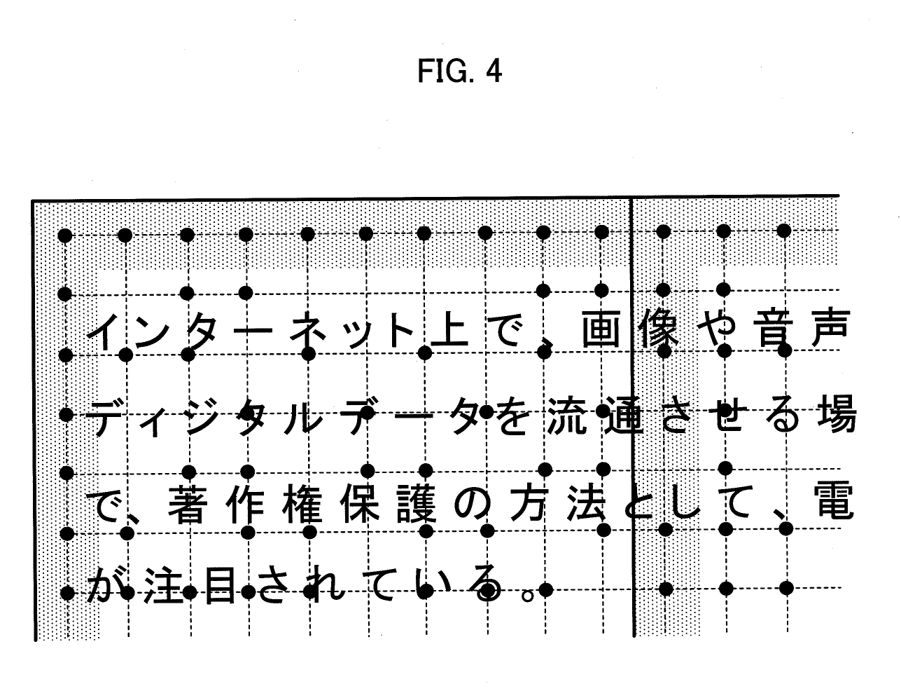

The arrangement determination part 166 determines, based on the image data of the document generated by the document image data generation part 160 (hereinbelow, simply “document image data”) and the image data of the additional information generated by the additional information image data generation part 164 (hereinbelow, simply “additional information image data”), the arrangement of the additional information image data in the document image data (or the arrangement of document image data in the additional information image data). The details of the arrangement of determination will be described later with reference to FIG. 4. The determined arrangement is held as a linear transformation coefficient and transmitted together with the document image data and the additional information image data to the additional information embedding part 168.

The additional information embedding part 168 embeds the additional information image data generated by the additional information image data generation part 164 in the document image data generated by the document image data generation part 160, in the arrangement determined by the arrangement determination part 166. More particularly, the additional information embedding part 168 superposes the document image data on the additional information image data in the arrangement determined by the arrangement determination part 166 by page of the document, thereby combines the document image data with the additional information image data. Note that it may be arranged such that the additional information image data is superposed on the document image data thereby combined with the document image data.

The image forming part 170 print-outputs, on a recording sheet, the document image data in which the additional information is embedded by the additional information embedding part 168.

FIG. 3 illustrates an example of the additional information image data generated by the additional information image data generation part 164 in FIG. 2.

As shown in FIG. 3, in the additional information image data, a unit image pattern represented as a dot pattern (hereinbelow, simply “unit dot pattern”) is arranged in a dot pattern region corresponding to a recording sheet size. For example, the unit dot pattern is arranged such that the total area of the dots is equal to or less than 1% with respect to the recording sheet.

In this example, 1 bit is represented by presence/absence of 1 dot, and the unit dot pattern includes 36-bit synchronization dot pattern and 64-bit additional information dot pattern. The size of 1 dot and the interval between the dots are previously determined. For example, the dot diameter is 100 lam and the dot intervals is 5 mm. When the dot interval is 5 mm, the interval of the unit dot pattern is 50 mm.

The synchronization dot patterns are respectively used for detection of a partition between the unit dot pattern and the next unit dot pattern. The additional information dot patterns respectively correspond to the additional information generated by the additional information generation part 140 in FIG. 2. When error correction coding is performed, BCH (64, 36, t=5) or the like is applied to the additional information dot pattern.

FIG. 4 is an explanatory view of determination of an arrangement of the additional information image data in document image data (or the arrangement of the document image data in the additional information image data) by the arrangement determination part 166 in FIG. 2.

First, in determination of an arrangement of additional information image data in document image data, the additional information image data is subjected to linear transformation on the document image data. More particularly, the additional information image data is subjected to at least one of XY-directional parallel translation (otherwise X-directional translation or Y-directional translation), XY-directional enlargement or reduction (otherwise, X-directional enlargement or reduction or Y-directional enlargement or reduction) and rotation. The linear transformation may be performed continuously or may be performed discontinuously.

Actually, to reduce load upon processing, the additional information image data itself is not subjected to the linear transformation but coordinates indicating the dot positions of the additional information image data are subjected to the linear transformation.

For example, when the dot coordinates of the additional information image data before the linear transformation are (x, y), the coordinates are parallel-translated to (x+a, y+b), enlarged or reduced to (ax, by), and simultaneously enlarged or reduced and rotated to (axcos θ+bysin θ, −axsin θ+bycos θ).

The arrangement determination part 166 calculates, as an evaluation point, the number of pixels when pixel values of the document image data in superposition of predetermined sized dots in the linear-transformed coordinates are greater than a predetermined threshold value. Further, the arrangement determination part 166 selects coordinates having the lowest evaluation point as coordinates when the interference between the additional information image data and the document image data (degree of overlap between the additional information image data and the document image data) is most improved, and holds the linear transformation coefficient used for the coordinates. That is, the arrangement determination part 166 holds the arrangement of the additional information image data in the document image data as a linear transformation coefficient.

Note that the evaluation point may be calculated as the number of pixels when a spatial frequency in the peripheral region of the document image data in superposition of predetermined sized dots in the linearly-transformed coordinates is greater than a predetermined threshold value.

In the above description, when an evaluation point has been calculated in all the linear-transformed coordinates, the coordinates are selected based on the evaluation points. It may be arranged, however, such that the linear transformation coefficient for the coordinates when the interference between the additional information image data and the document image data is improved to a certain degree (e.g., reduced by 30% in comparison with the previously calculated evaluation point) is held, and the processing is terminated.

Next, in determination of arrangement of the document image data in the additional information image data, the document image data is subjected to linear transformation on the additional information image data.

In this case, the arrangement determination part 166 performs the linear transformation on the document image data, calculates, as an evaluation point, the number of unit dot patterns when pixel values (or pixel density values, spatial frequency in the peripheral region or the like) of the additional information image data in superposition with the document image data are greater than a predetermined threshold value, and holds the liner conversion coefficient where the interference between the additional information image data and the document image data is most improved.

### [Detection of Additional Information]

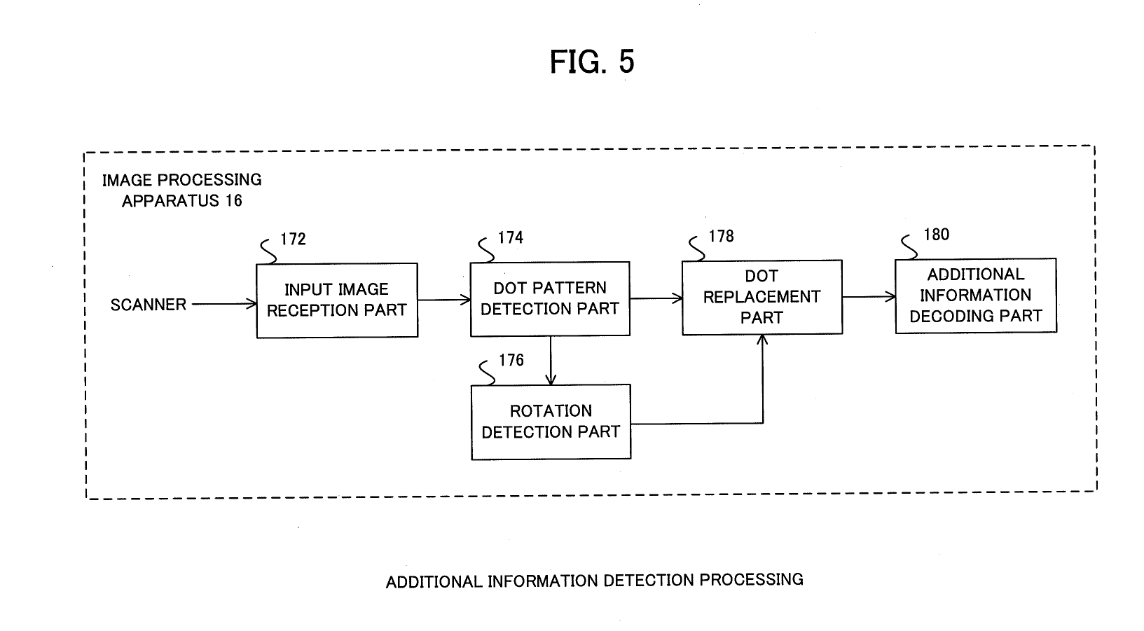

FIG. 5 is a block diagram showing a functional configuration when the image processing apparatus 16 in FIG. 1 detects the additional information.

As in the case of the functions shown in FIG. 2, the functions shown in FIG. 5 are realized by execution of a computer program by the CPU in the image processing apparatus 16.

The image processing apparatus 16 has an input image reception part 172, a dot pattern detection part 174, a rotation detection part 176, a dot replacement part 178 and an additional information decoding part 180.

Hereinbelow, the above respective elements will be described.

The input image reception part 172 receives image data, in which additional information is embedded, as an input image, from a scanner (not shown) of the image processing apparatus 16.

The dot pattern detection part 174 detects a dot pattern embedded as additional information from the input image received by the input image reception part 172. More particularly, the dot pattern detection part 174 detects an image smaller than a predetermined threshold value as dots in the binarized input image. Further, it may be arranged such that a dot pattern to be detected is prepared as a template, and the dot pattern detection part 174 detects, as a dot pattern, a pattern having a high probability of correspondence with the template (e.g., 90% correspondence with the template).

The rotation detection part 176 detects rotation of the additional information image data (or the document image data) based on the dot pattern detected by the dot pattern detection part 174. More particularly, the rotation detection part 176 detects rotation by determining an angle with respect to a virtual orthogonal lattice, in each dot of the detected dot pattern. Note that among straight lines connecting proximity dot pairs between the respective dots of the detected dot pattern and the dots in nearest positions from the respective dot positions, the virtual orthogonal lattice is generated based on straight lines in mutually different directions. Further, it may be arranged such that the rotation detection part 176 detects rotation by performing Fourier transformation on an image in the central position of the detected dot pattern, then detecting dot interval and directions based on power spectrum distribution on its spatial frequency.

The dot replacement part 178 allocates the virtual orthogonal lattice to the additional information image data based on the rotation angle detected by the rotation detection part 176, and replaces the presence/absence of dot on the periphery of the lattice intersection with a two-dimensional array. For example, when a dot exists on the periphery of the lattice intersection, the dot replacement part 178 sets the value in the lattice intersection to “1”, while when no dot exists on the periphery of the lattice intersection, sets the value in the lattice intersection to “0”.

The additional information decoding part 180 detects a partition between a unit dot pattern and the next unit dot pattern in the dot pattern detected by the dot pattern detection part 174, based on the two-dimensional array generated by the dot replacement part 178. Further, the additional information decoding part 180 extracts the additional information dot pattern from the dot pattern detected by the dot pattern detection part 174 based on the detected partition.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a document image acquisition unit that acquires a document image;
an additional information image acquisition unit that acquires an additional information image in which additional information added to the document image acquired by the document image acquisition unit is represented with a dot array of dots having a predetermined size and interval;
a determination unit that determines an arrangement of at least one of the document image and the additional information image so as to reduce interference in superposition of the document image acquired by the document image acquisition unit and the additional information image acquired by the additional information image acquisition unit; and
a superposition unit that superposes the document image on the additional information image in the arrangement determined by the determination unit.

2. The image processing apparatus according to claim 1, wherein the determination unit performs linear transformation on at least one of the document image and the additional information image and determines the arrangement.

3. The image processing apparatus according to claim 1, further comprising an image output unit that outputs a superposed image superposed by the superposition unit using the document image, the additional information image and the arrangement determined by the determination unit.

4. The image processing apparatus according to claim 2, further comprising an image output unit that outputs a superposed image superposed by the superposition unit using the document image, the additional information image and the arrangement determined by the determination unit.

5. The image processing apparatus according to claim 3,
wherein the document image acquisition unit acquires the document image having a plurality of pages,
the determination unit determines the arrangement of at least one of the document image and the additional information image so as to reduce interference in superposition between the document image acquired by the document image acquisition unit and the additional information image acquired by the additional information image acquisition unit for each page of the document image; and
the image output unit outputs the superposed image superposed by the superposition unit using the document image, the additional information image and a plurality of the arrangements determined by the determination unit.

6. The image processing apparatus according to claim 4,
wherein the document image acquisition unit acquires the document image having a plurality of pages,
the determination unit determines the arrangement of at least one of the document image and the additional information image so as to reduce interference in superposition between the document image acquired by the document image acquisition unit and the additional information image acquired by the additional information image acquisition unit for each page of the document image; and
the image output unit outputs the superposed image superposed by the superposition unit using the document image, the additional information image and a plurality of the arrangements determined by the determination unit.

7. The image processing apparatus according to claim 3, further comprising a detection unit that detects the additional information image, represented with the dot array of dots having the predetermined size and interval, and subjected to liner transformation, from the superposed image outputted by the image output unit.

8. The image processing apparatus according to claim 4, further comprising a detection unit that detects the additional information image, represented with the dot array of dots having the predetermined size and interval, and subjected to liner transformation, from the superposed image outputted by the image output unit.

9. The image processing apparatus according to claim 1, wherein the determination unit calculates, as an evaluation point, the number of pixels when pixel values of pixels in superposition of the document image acquired by the document image acquisition unit and the additional information image acquired by the additional information image acquisition unit are greater than a predetermined value, and determines a position with a low evaluation point as the arrangement.

10. The image processing apparatus according to claim 1, wherein the determination unit calculates, as an evaluation point, the number of pixels when a spatial frequency of an image in superposition of the document image acquired by the document image acquisition unit and the additional information image acquired by the additional information image acquisition unit is greater than a predetermined value, and determines a position with a low evaluation point as the arrangement.

11. The image processing apparatus according to claim 1, wherein the determination unit performs linear transformation on at least one of the document image and the dot array representing the additional information image and determines the arrangement.

12. A computer readable medium storing a program causing a computer to execute a process for image processing, the process comprising:
acquiring a document image;
acquiring an additional information image in which additional information added to the acquired document image is represented with a dot array of dots having a predetermined size and interval;
determining an arrangement of at least one of the document image and the additional information image so as to reduce interference in superposition of the acquired document image and the acquired additional information image; and
superposing the document image on the additional information image in the determined arrangement.
